(19) United States
(12) Patent Application Publication
(10) Pub. No.: US 2013/0211567 A1
(43) Pub. Date: Aug. 15, 2013

(54) SYSTEM AND METHOD FOR PROVIDING AUDIO CONTENT ASSOCIATED WITH BROADCASTED MULTIMEDIA AND LIVE ENTERTAINMENT EVENTS BASED ON PROFILING INFORMATION

(71) Applicants: Arthur Oganesyan, Burbank, CA (US); Joshua Macciello, Studio City, CA (US); Arthur A. Gaplanyan, North Hollywood, CA (US); Gevork Mkrtchyan, Glendale, CA (US); Rodney W. DeMay, Woodland Hills, CA (US)

(72) Inventors: Arthur Oganesyan, Burbank, CA (US); Joshua Macciello, Studio City, CA (US); Arthur A. Gaplanyan, North Hollywood, CA (US); Gevork Mkrtchyan, Glendale, CA (US); Rodney W. DeMay, Woodland Hills, CA (US)

(73) Assignee: ARMITAL LLC, Reno, NV (US)

(21) Appl. No.: 13/878,975

(22) PCT Filed: Oct. 12, 2011
(86) PCT No.: PCT/US11/55952

§ 371 Date: Apr. 11, 2013

Related U.S. Application Data
(60) Provisional application No. 61/392,306, filed on Oct. 12, 2010.

(51) Int. Cl. G06F 3/16

(52) U.S. Cl. CPC G06F 3/16
USPC 700/94

(57) ABSTRACT

A system and method for providing primary and secondary audio content over a wireless network at a public or private forum to at least one mobile audio receiver device includes receiving the primary audio content from a content provider over a corresponding communications path; transmitting selected primary audio content from the communications path continuously over the wireless network to the receiver; terminating transmission of the selected primary audio content to the receiver at predetermined time intervals or on-demand; transmitting the secondary audio content over the wireless network to the receiver while the selected primary audio content transmission is terminated, the secondary audio content being transmitted for a second predetermined time interval or on-demand; and transmitting the selected primary audio content from the corresponding communications path over the wireless network to the receiver after the secondary audio content being transmitted for a second predetermined time interval or on-demand has terminated.

### CROSS REFERENCE TO RELATED APPLICATION

This patent application claims the benefit of U.S. Provisional Application Ser. No. 61/392,306, filed Oct. 12, 2010, the contents of which are incorporated by reference herein in its entirety.

### BACKGROUND OF THE INVENTION

1. Field of the Invention

The present invention relates to multicasting audio information to listeners participating in broadcasted multimedia and live entertainment events, and more specifically, to providing participating subscribing listeners with non-interactive and interactive audio content associated with broadcasted multimedia, live entertainment events and advertisements over a wireless network.

2. Related Prior Art

Many consumers enjoy watching or listening to multimedia content, such as sporting events, concerts, among other multimedia entertainment events in public or local forums. These local forums can include stadiums, sports bars, museums, zoos, and parks, among other well-known public, private or local forums. Depending on the type of forum, the noise level from the surrounding environment can become distracting to those trying to listen to the event or render it impossible for them to hear and understand the audio content associated with the video being watched. Alternatively, where an entertainment event is being presented in a forum as background entertainment, it can become distracting to the persons trying to converse with each other.

For example, restaurants and bars often show a sporting event on one or more televisions by the bar so that some customers can watch the game. In many instances, the volume is muted so that other customers who have little or no interest in the “game” can converse without the distraction of the audio from the television. Thus, conflicting interests arises as those viewing the publicly broadcasted game will often ask for the volume to be increased, while those with less or no interest in the game will ask for the volume to be lowered or muted.

Often, the proprietor or management at the local forum will mute the volume and provide closed-captioning capabilities when available, such as at a restaurant or sports bar where the patrons interested can read the closed captioning text while watching the broadcasted game on the television set. However, watching a sporting event on a television with closed captioning text does not provide the same experience or level of excitement as listening to the broadcasted game by an announcer, since the closed-captioning text does not provide the emotional aspects of the broadcasted audio content.

Similarly, at live entertainment events such as sports stadiums, it is at times virtually impossible to hear what is being the due to the great distances between the live performer(s) and the fans, as well as poor audio systems at the local entertainment forum, and/or other distractions and noise from the surrounding environment.

At the opposite end of the spectrum where low levels of sound are desirable, such as at museums, golf events, among other public forums where “silence is considered golden”, it is often difficult to provide audio content without disturbing other persons in the forum.

For example, it is well known that headsets are often available for a small fee at museums so that visitors can listen to prerecorded audio information regarding a particular work of art (e.g., painting, sculpture, and the like) or other historical artifact. The headsets are useful for listening to information about the artwork from audio content stored either locally on the headset device itself or remotely at a local server. The headsets operate with the user standing in proximity of the work of art and the user selects a predetermined playback track to listen to content stored in local memory of the device. Alternatively, the user tunes the headset to a predetermined frequency to receive the broadcasted or point-casted prerecorded information over a wireless network from a remote server.

Even though the headsets can provide prerecorded information to the listener, these devices do not provide “live” information that is occurring in real time. Moreover, none of the public or local forums have the ability to target individual listeners using headsets with propriety information, such as advertisements associated with local sponsors, interactive audio associated with games, surveys and the like, as well as promotions from the local forum.

Therefore, it is desirable to provide a system and method for enabling subscribers to the system to receive audio content, which is associated with broadcasted multimedia and live entertainment events, based on profiling information of the selected listeners.

### SUMMARY OF THE INVENTION

The shortcoming of the prior art are overcome by the present invention which includes a system that provides wireless transmission of one or more audio/data signals sources such as, for example, the audio from an A/V tuner (cable, satellite, TV, Radio, and the like), a CD/DVD/BD or similar media, streamed audio/data from the Internet, an internal/external stored digital memory, USB connected media, and/or audio through fiber optic data communication medium from one or more broadcasting devices to one or more listening/playback devices.

In one embodiment, the wireless transmission is sent by a base station and received by a mobile receiver, which processes the audio signal received from one or more of the sources, and outputs the audio signal through a speaker headset which is placed over the ears of an end-user.

The receiver can provide an interactive environment by processing end-user input data received through push-buttons or similar end-user input devices, and send the input data as wireless signals to the base station for further data processing. In addition to the base station's primary function of transmitting audio signals to the receiver, the base station is also capable of downloading/uploading data to remote servers through the Internet, downloading/uploading data to/from a receiver, and downloading/uploading data with other base stations through a wired or wireless connection to thereby increase the system's overall functionality, capacity, and efficiency. Accordingly, where more than one audio/data source is available, the receiver provides the user with the ability to select a particular source either automatically or by end-user input via channel selection. Multiple receivers are able to transmit/receive audio/data to/from a single or multiple base station(s), depending on the particular system installation scheme at a particular location. Owners of the base station/receiver system have the ability to transmit/receive data to/from their base station remotely through an Internet-Based Control Panel Environment that relays this data to remote server(s), which in turn transmit/receive the data to/from the receivers.

In one embodiment of the present invention, a method for providing primary audio content and secondary audio content over a local wireless network at a public or private forum to at least one mobile audio receiving device includes the steps of: receiving the primary audio content from one or more content providers over a corresponding one or more communications paths; transmitting selected primary audio content from one of the communications paths continuously over the local wireless network to the at least one mobile audio receiving device; terminating transmission of the selected primary audio content to the at least one mobile audio receiving device at predetermined time intervals or on-demand; transmitting the secondary audio content over the local wireless network to the at least one mobile audio receiving device while the selected primary audio content transmission is terminated, the secondary audio content being transmitted for a second predetermined time interval or on-demand; and transmitting the selected primary audio content from the corresponding communications path continuously over the local wireless network to the at least one mobile audio receiving device after the secondary audio content being transmitted for a second predetermined time interval or on-demand has terminated.

In one aspect, the method includes tracking activation of the at least one mobile audio receiving device while receiving the selected primary audio content over the local wireless network. The tracking step can include receiving periodic heartbeat or ping messages from the at least one mobile audio receiving device over the local wireless network; and transmitting the received periodic heartbeat or ping messages to a remote server of a service provider that monitors status of the at least one audio receiving device.

In another aspect, the method further comprises deactivating the at least one audio receiving device in response to an absence of receiving the periodic heartbeat or ping messages for a predetermined time. In yet another aspect, the method includes storing, at a remote server, profile information associated with the public or private forum. In still another aspect, the method further comprises transmitting the secondary audio content to the at least one mobile audio receiving device based on profile information of the public or private forum and/or one or more end-users.

In another aspect, the method includes configuring, over the local network and/or the internet, channel selection for providing the selected primary audio content and the secondary audio content to the at least one mobile audio receiving device.

In another aspect, the step of transmitting the selected primary audio content and the secondary audio content over a local wireless network comprises transmitting the selected primary audio content and the secondary audio content over a local non Wi-Fi wireless network. Alternatively, the step of transmitting the selected primary audio content and the secondary audio content over a local wireless network comprises transmitting the converted primary audio content and the secondary audio content over a local Wi-Fi network.

In still another aspect, the at least one mobile audio receiving device has Internet access over the local Wi-Fi network, and the method further comprises providing a specialized application program to the at least one mobile audio receiving device, the specialized application program including at least one user interface for controlling channel selection for receiving the selected primary and secondary content over the local Wi-Fi network.

In another embodiment, a system for providing primary audio content and secondary audio content over a local wireless network at a public or private forum to at least one mobile audio receiving device comprises: at least one mobile audio receiving device configured to receive selected primary audio content and the secondary audio content over the local wireless network; a base station having a plurality of communication paths, memory for storing profile information of the public or private forum, and at least one switch for selecting the primary audio content from one or more content providers, the base station further including at least one processor coupled to the memory and a base station configuration program stored in the memory and executable by the at least one processor, the base station configuration program operable to: receive the primary audio content from the one or more content providers over a corresponding one or more communication paths of the plurality of communication paths; transmit the selected primary audio content received from a corresponding communications path continuously over the local wireless network to the at least one mobile audio receiving device; terminate transmission of the selected primary audio content to the at least one mobile audio receiving device at predetermined time intervals or on-demand; transmit the secondary audio content over the local wireless network to the at least one mobile audio receiving device at the second frequency while the selected primary audio content transmission over the local wireless network is terminated, the secondary audio content being transmitted for a second predetermined time interval or on-demand; and transmit the selected primary audio content continuously over the local wireless network to the at least one mobile audio receiving device after the secondary audio content being transmitted for a second predetermined time interval or on-demand has terminated.

In one aspect, the local wireless network is a Wi-Fi network. Alternatively, the local wireless network can be a non Wi-H wireless network operating at a predetermined frequency. For example, the operating frequency can be 900 MHz, 2.4 Ghz, or 5.0 GHz, although such frequencies are not considered limiting. In another aspect, the base station includes a transceiver dedicated to each of the plurality of communication channels.

In still another aspect, the system includes a remote server communicably coupled to the base station via the internet. The remote server includes a second memory for storing the profile information of the public or private forum and a set of predetermined rules for determining assignment of the selected primary and secondary audio content to each of the plurality of communication paths. At least one second processor is coupled to the second memory; and an authorization program and a base station management program is stored in the second memory and executable by the at least one second processor. The remote server authorization program is operable to: activate operational capabilities of the base station over the internet; send, over the internet, configuration parameters for determining assignment of the primary and secondary audio content to each of the plurality of communication paths of the base station; and send, over the internet, a command signal to the base station to activate the at least one mobile audio receiving device over the local wireless network.

In another aspect, the remote server is further operable to monitor activation of each of the at least one mobile audio receiving devices.

In one aspect, the primary audio content received at the base station from the primary content provider includes at least one of broadcasted television programming, real-time audio content from a live performance, and digitized audio content stored on a memory device. Further, the secondary audio content can include at least one of advertisements, command instructions to operate the mobile audio receiving device, and command instructions for interacting with the primary audio content.

In another aspect, the at least one mobile audio receiving device is activated only at the public or private forum. In a further aspect, the at least one mobile audio receiving device comprises: a microcontroller operable to execute input commands from the end-user to select one of the plurality of communication paths of the base station; at least one transceiver operable to receive the selected primary audio content and the secondary audio content over the local wireless network; and a speaker for outputting sounds associated with the selected primary audio content and the secondary audio content to the end-user.

### BRIEF DESCRIPTION OF THE DRAWINGS

Further advantages and features of the present invention will become apparent from the detailed description of a preferred embodiment of the invention with reference to the accompanying drawings, in which:

FIG. 1 is a block diagram of an illustrative system for providing audio content associated with broadcasted multimedia and live entertainment events based on profiling information in accordance with the present invention;

FIG. 2 is a schematic block diagram of a mobile audio receiving device suitable for receiving the audio content in the system of FIG. 1;

FIG. 3 is a schematic block diagram of a base station suitable for transmitting the audio content in the system of FIG. 1;

FIG. 4 is a block diagram of a remote server suitable for authenticating, authorizing and accessing subscriber accounts in the system of FIG. 1;

FIG. 5 is a flow diagram of a method of operation for providing audio content from a base station to a plurality of mobile receiving devices in the system of FIG. 1;

FIG. 6 is a flow diagram of a method of operation of the base station of FIG. 5 illustrating self-configuration and monitoring activities of one or more mobile audio receiving devices of FIG. 2;

FIGS. 7A and 7B collectively form a flow diagram of a method of operation of the mobile audio receiving device of FIG. 5 illustrating self-initialization and configuration, and communications with the base station in accordance with the present invention;

FIG. 8 is a flow diagram of a method of operation of a remote server of FIG. 5 illustrating authentication, authorization and access of subscribers to the system of FIG. 1; and

FIGS. 9A-9C each show elevational front and perspective views of a cellular phone having internet capabilities suitable for use as a mobile receiver in the system of FIG. 1.

To facilitate understanding of the invention, identical reference numerals have been used, when appropriate, to designate the same or similar elements that are common to the figures.

### DETAILED DESCRIPTION OF THE INVENTION

For purposes of illustration and clarity, the present invention is discussed in the context of a consumer or other end-user using a mobile audio receiving device (e.g., audio headset or cell phone) for listening to primary and/or secondary audio transmissions that are broadcasted and/or point-casted by a merchant or other commercial or private entity. The primary audio transmissions can include various types of audio programming that are associated with television programming provided by cable, telephone or other program media content providers. Other types of primary audio transmission can also include broadcasted audio provided by museums, playhouses, theaters, sports stadiums, zoos, hospitals, airports, train stations, bus depots, shopping malls and other multimedia content providers. Additionally, the present invention provides secondary audio content that can be associated with the local service provider, retailer or proprietor of the establishment broadcasting the primary audio content.

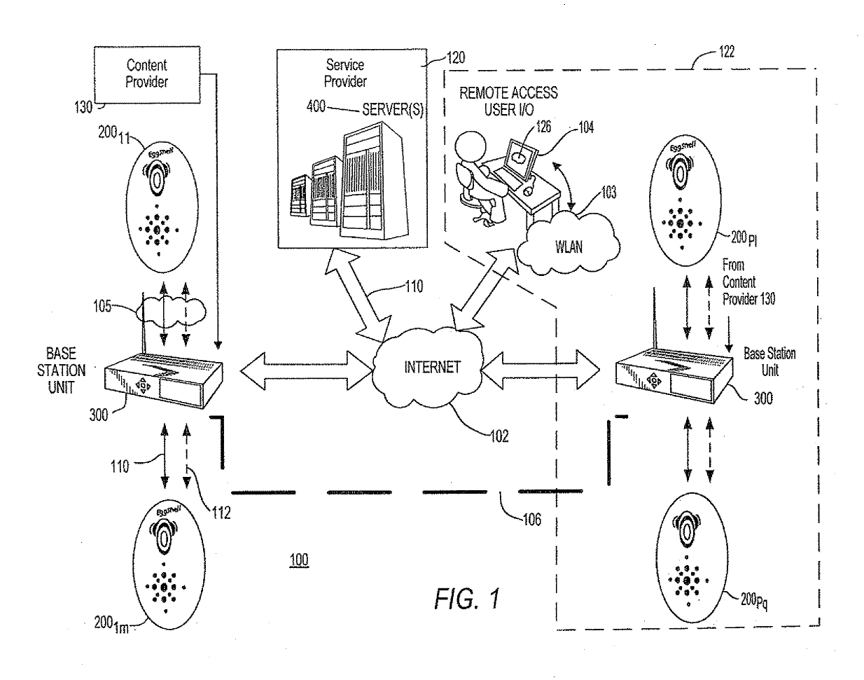

FIG. 1 is a block diagram of an exemplary system 100 for providing audio content associated with broadcasted multimedia and live entertainment events based on profiling information in accordance with the present invention. The system 100 includes a retail establishment 122 having at least one base station 300₁ through 300ₚ (collectively base stations 300) that communicate wirelessly with a service provider 120 having one or more remote servers 400 via the Internet 102 and/or other local area network (LAN), such as any well-known wireless network 103 (e.g., Wi-Fi, Bluetooth, cellular and the like). The base stations 300 receive primary audio content 110 from a content service provider 130, such as a cable provider, satellite provider, telephone provider that broadcasts multimedia content, e.g., television programming or other multimedia content. Such content from the content providers 130 is hereinafter known as “primary” audio content 110, which is selectively broadcasted to one or more mobile audio receiving devices 200, such as receiving devices 200₁₁ through 200₁ₘ associated with the first base station 300₁ and receiving devices 200ₚ₁ through 200ₚₘ associate with the second base station 300ₚ. For example, a retail establishment 122 such as a sports bar or restaurant can have one or more base stations 300 to provide audio content to their customers or patrons. A person of ordinary skill in the art will appreciate that each base station 300 can provide wireless transmission of one or more audio/data signals sources, such as the audio from an A/V tuner (cable, satellite, TV, Radio, and the like), a CD/DVD/BD or similar media, streamed audio/data from the Internet, audio stored on an internal/external digital memory device, and/or audio transmitted through a fiber optic data communication medium from one or more broadcasting devices to one or more end-user listening/playback, i.e., receiving devices. 200

The quantity of base stations 300 at a retail establishment 122 or other local forum is based on the service requirements of such hosting retailer or establishment 122, including geographical areas of coverage and expected number of receivers 200 that will be receiving audio content at a particular time. Accordingly, multiple base stations 300 can be linked at a given establishment to provide greater service coverage and available channels.

The base station 300 is capable of simultaneously broadcasting, multicasting or point-casting a unique streams of audio/data over a predetermined number of output channels. The streams of audio/data are received by the base station 300 from any of a number of content providers (i.e., audio sources) 130 which are provided through a predetermined number of input ports. The audio content from the various input sources can be received through physical input jacks available on the base station 300 or streamed over the Internet to the base station, either through a wired or wireless connection. The number of input audio sources can differ from the predetermined number of output channels. For purposes of better understanding the invention, the various content providers (input sources) can include audio content from cable/satellite boxes, CD/DVD/BD boxes or other audio equipment typically including a physical AUDIO-OUT port; Internet audio streams extracted from a built-in wired/wireless network adapter; an electronic hardware device with audio files stored thereon and which is connected via a USB connector or other well-known input connection; other internal or external storage devices; among other well-known audio content sources or providers.

As described in further detail below, a secure software configuration control panel 126 for the base station 300 enables the proprietor or management of a public or private forum or other proprietary establishment 122 to configure each output channel (i.e., communication path) to receive the audio/data to be broadcasted from any one of the aforementioned audio input sources.

For example, sports bar has a single a base station 300 having ten physical TRS input connectors, each of which is coupled to an audio content source. For sake of simplicity, each TRS input connector is communicably coupled via a signal conductor to a different satellite set-top box. Accordingly, each of the ten TRS input connectors will have one input from each of the ten satellite boxes at the sports bar establishment. In this manner, the sports bar has ten different TV channels being broadcast to at least ten televisions at the sports bar. A person of ordinary skill in the art will appreciate that one or more of the output channels of the base station 300 can be split to provide the same audio streams to multiple televisions. However, since the audio of the split information remains the same, only one satellite set-top box needs to be connected to a single TRS input connector of the base station to receive and broadcast the audio content over a channel.

Additionally, the base station 300 can be communicably connected to the internet, which streams audio/data content to the base station 300. Further, an external CD/DVD/BD player can be attached to the base station 300 via a USB connector. The proprietor of the sports bar can use the configuration control panel 126 to configure the output channels of the base station to broadcast from any one of the input sources.

For example, if the base station 300 at the sports bar has a ten channel output capacity, this means the base station can broadcast simultaneously over the ten output channels from any number of different sources that are communicably coupled to the base station. The audio/data can be provided by the physical inputs in the back of the base station, the audio/data provided by the network adapter (which can be accessed by any of the ten channels), and the external CD/DVD/BD player attached via USB (which can also be accessed by any of the ten channels).

By using the configuration control panel 126, the proprietor or manager of the retail establishment 122 has the capability to choose and assign which one of the above sources that a specific channel will pull from to broadcast its audio/data to the end users. For example, the configuration control panel 126 enables a proprietor of an establishment 122 to illustratively configure the output channels of the base station 300 to receive audio content from various audio content sources illustratively as follows: Channel 1: rear physical input; Channel 2: rear physical input; Channel 3: rear physical input; Channel 4: internet stream; Channel 5: Internet stream; Channel 6: USB device; Channel 7: rear physical input; Channel 8: internet stream; Channel 9: USB device; and Channel 10: rear physical input. In this manner, the configuration control panel 126 enables the proprietor of the private or local forum to select each channel and switch between available audio content sources, on-demand.

Referring again to FIG. 1, the service provider 120 can be an entity that provides the present system 100 for delivering primary and secondary audio content at a retailer 122 or other forum to end-users having mobile receiving devices 200 in accordance with the present invention. The remote servers 400 of the service provider 120 can include a web server that provides web pages for accessing an account through the remote computer device 104 of an account holder. The account holder is associated with the retailer 122 or local forum, which can illustratively be a proprietor of a bar, restaurant or other entity associated with providing one or more base stations 300 at a location to distribute audio content to one or more end-user customers of the retailer 122. The retailer 122, i.e., account holder, can access the account information by logging in through their computer device 104 and authenticating the account. Thereafter, the account holder can update profile information, pay invoices, provide prerecorded voice messages for playback to the mobile receiving devices 200, register new base stations 300, and the like.

The remote servers 400 of the service provider 120 process data received from the base station(s) 300 and from remote computer devices 104 which utilize an internet-based control panel 126 that enables the retailer 122 to view/modify account information remotely over the internet 102. The remote servers 400 can also send data back to the retailer via the control panel 126, as well as to the mobile receivers 200. The remote server(s) 400 are programmed to determine whether or not particular receivers 200 are permitted to operate by processing the retailer's login information. Also, the remote servers 400 can remotely program the receivers 200 with specific data by processing the retailer's login information. The base station 300 and receiver-specific data, such as MAC addresses, physical location, duration of use, and the like are processed and stored by the remote servers 400 for authentication and marketing purposes as described below in further detail.

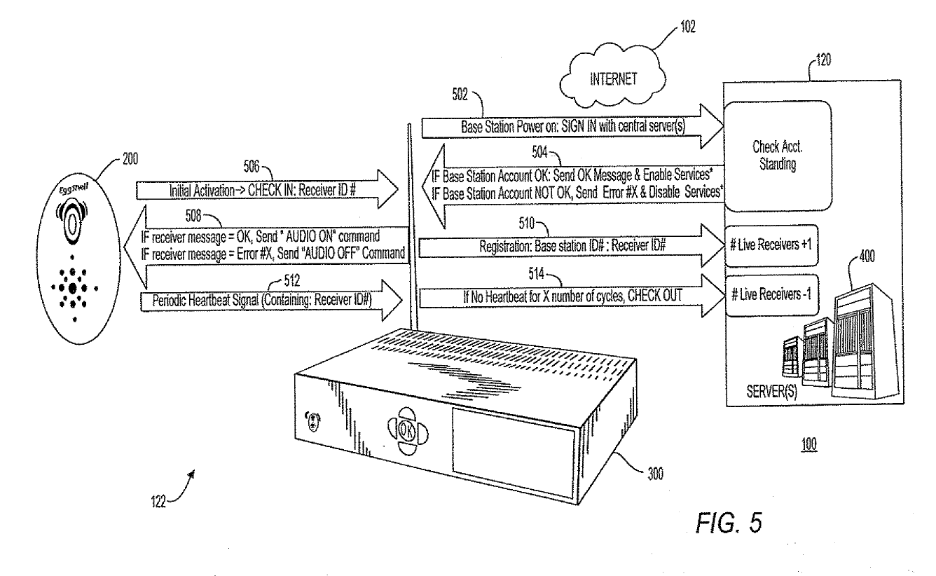

Referring to FIG. 5, a flow diagram illustrating system operation for providing audio content from a base station 300 to a plurality of mobile receiving devices 200 is shown. At step 502, the base station 300 is powered on and logs in with a central server 400 of service provider 120 via a wireless network, such as the Internet 102. At step 504, if the base station 300 is not authenticated, and error message is sent from the server 400 to the base station and the services are disabled. If however, at step 504, the base station 300 is authenticated, a validation/authentication message is sent to the base station 300 from the central server 400 and services for the base station 300 are enabled. At step 506, a mobile audio receiving device 200 is powered on by an end user and the receiving device automatically logs in with the enabled base station 300. The receiving device 200 sends a check-in message containing its unique ID number, which is preprogrammed in the microcontroller of the receiving device 200. In one embodiment, the receiver 200 and base station 300 communicate over a dedicated non Wi-Fi wireless network such as a 2.4 GHz wireless network, although such wireless network frequency is not considered limiting.

At step 508, if the base station 300 receives a valid ID message from the receiver 200, the receiver receives a confirmation signal, such as an audio signal. Otherwise, if the base station 300 does not receive a valid ID message, for example, due to interference in the transmission signal, a counterfeit receiver, an invalid receiver ID, and the like, the receiver 200 is denied activation.

At step 510, the base station 300 sends the registration information to the server 400 for authentication and tracking. In one embodiment, the base station 300 receives the “check-in” message and appends its own unique ID number (e.g., preprogrammed in the microcontroller and/or its MAC address) and sends a registration message containing the ID numbers of both the receiving device 200 and base station 300 through its internet connection 102 to the central server 400 of the service provider 120. The receiving device 200 does not enable audio output until an OK message is received from the base station 300, and the base station 300 will not send the OK message to the receiving device 200 until it is enabled by the OK message from the central server 400.

Once the server 400 validates the registration of the receiving device 200, the receiving device is activated and can receive audio information, such as primary audio 110 from an external content provider (e.g., television programming, and the like), as well as secondary audio from the retailer 122.

In one embodiment, the number of audio receiving devices 200 that are active at any given time at the retailer establishment 122 is monitored for purposes of advertising and profiling. Monitoring the active receiving devices 200 is accomplished by periodically receiving heartbeat or ping messages from each active receiving device 200 and forwarding the heartbeat/ping messages to the server 400 of the service provider 120. In particular, at step 512, periodic heartbeat or ping signals are sent by the receiving device 200 to the base station 300 illustratively over a local 900 MHz, 2.4 GHz or 5.0 GHz wireless network 105, although such frequencies are not considered limiting. At step 514, the base station 300 forwards the heartbeat/ping information to the server 400 for tracking purposes. If the heartbeat/ping information is absent for a predetermined time or counts, the base station sends a “check-out” message to the server 400 to notify the server 400 that the receiving device 200 having a particular ID number is no longer active. The server 400 updates its status files for the particular receiving device and is denied any further audio content. A particular receiving device 200 may become inactive (off-line) due to the user moving out of range of the base station 300 at the retailer or establishment, or low battery power. Assuming the battery power of the receiving device 200 is sufficient, the end-user can later reactivate the receiving device 200 by positioning the receiving device 200 within transmission range of the same base station at the retailer or within transmission range of another base station located elsewhere, i.e., at another retail establishment. In this manner, an end-user can use a receiving device 200 at various times and/or locations.

During normal operation, the receiving device 200 can receive primary audio content 110 from a content provider 130 via the base station 300 such as audio associated with television programming, audio from a museum, hospital, stadium or any other location that a listener can receive audio content while viewing an event or other subject matter. While receiving the primary audio content 110 from the content provider 130, secondary audio content 112 can be sent to the receiving device 200 by the retailer 122 via the base station 300. The secondary content 112 can include instruction of use, or advertisements from the service provider 120, or advertisements or other information from the retail establishment 122 facilitating the base station 300.

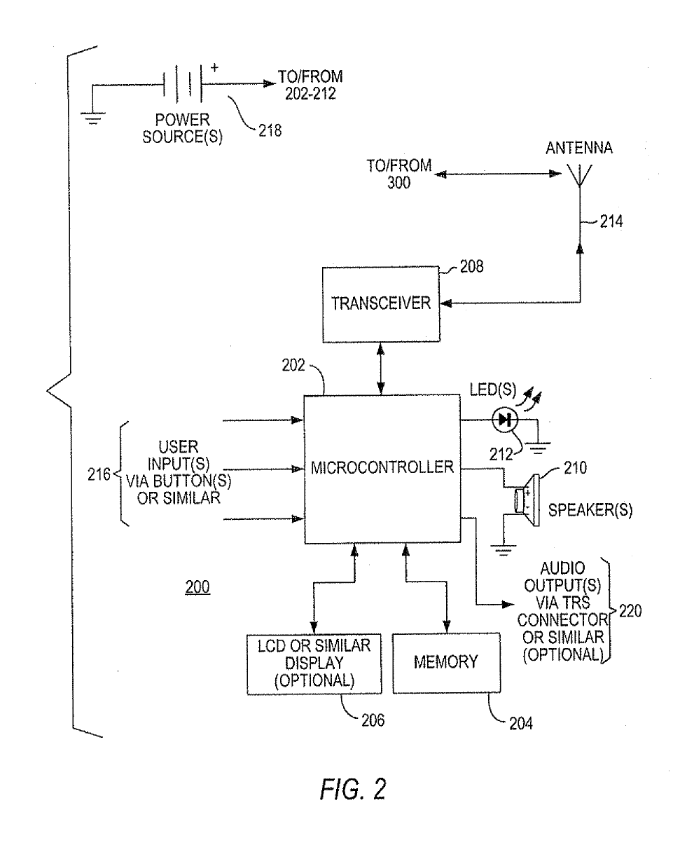

Referring to FIG. 2, a schematic block diagram of a mobile audio receiving device 200 suitable for receiving primary and secondary audio content 112 in the system of FIG. 1 is shown. The audio receiving device 200 includes a microcontroller 202 which executes data and programs stored in memory 204, in accordance with the present invention. A transceiver 208 communicates with the microcontroller 202 for transmitting login information and ping signals to the base station, as well receiving data messages and prerecorded voice messages, i.e., secondary audio content 112. The transceiver 208 communicates wirelessly with the base stations 300 through the antenna 214 over a dedicated wireless network 105.

The mobile receiver 200 is primarily used to receive audio data in digital format, convert this data to an analog signal, and output the analog audio signal through speaker(s) 210 to the end-user. Received data can also contain various types of system configuration information, such as channel availability, menu systems, and user input/control details, to name a few. In addition to receiving data, the mobile receiver 200 also has the ability to transmit data to the base station 300 over the wireless network 105. This data can include receiver specific data such as MAC address, duration of use, and the like, or data received by end-user input via pushbutton(s) or similar input devices.

More specifically, the microcontroller 202 controls the functional aspects of the receiving device 200, which includes, but is not limited to managing wireless communications, including security protocols, decoding audio streams from the transceiver 208, and providing playback locally to the speaker (e.g., mono) 210 or remotely via a stereo headphone jack 220. The microcontroller 202 can be a model no. ATXMega32A4 microcontroller from Atmel Corporation of San Jose, Calif., among other well-known microcontrollers.

The microcontroller 202 is capable of performing all the necessary functions and computations to effectively process all data received from base station(s) 300 at the retailer 122. These functions include, but are not limited to digital to analog conversion of audio data received from the base station 300 via the transceiver 208; output converted audio data to the speaker(s) 210; control of LED(s) 212 for display and/or notification purposes; receive and process data from end-user input via push/touch button(s) 216 or similar input device(s); read/write pertinent data to an on-board memory device 204; prepare pertinent data to be transmitted to the base station(s) 300; receive system configuration data from base station(s); and allow for programming/re-programming of instructions, memory, etc. by means of applying system configuration data received from the base station(s) 300.

The playback of audio includes streamed audio and voice announcements for feedback during user interaction (i.e., volume setting, channel selection, menu settings and the like). Additionally, the microcontroller 202 provides activation status with the local base station 300, as well as provides battery strength, wireless signal strength, and validates and maintains local system information (e.g., languages, menu systems, button configuration, channel configuration and the like.)

The memory 204 can be a flash memory device, expanded memory devices, among other well-known memory devices. The memory 204 can be used to store voice announcements for volume, channel and multiple choice answers to interactive trivia game play and/or polls (e.g., voice recordings of the letters A-Z and/or numbers 0-9). In one embodiment, when a user changes a setting, e.g., volume or channel, the microcontroller 202 will playback an audio snippet to the user associated with the setting selection or change.

The transceiver 208 transmits/receives digitized, packetized data to/from the base station 300 via the antenna 214 using one or more protocols such as IEEE 802.11, IEEE 802.15.4, etc. with specifications such as ZigBee, BitCloud, Ipv6/6LowPAN, and the like. The transceiver 204 can be a 2.4 GHz transceiver such as model no. AT86RF231 fabricated by Atmel Corporation or transceiver model no. TRC104 fabricated by RF Monolithic, Inc of Dallas Tex., among other well-known transceivers.

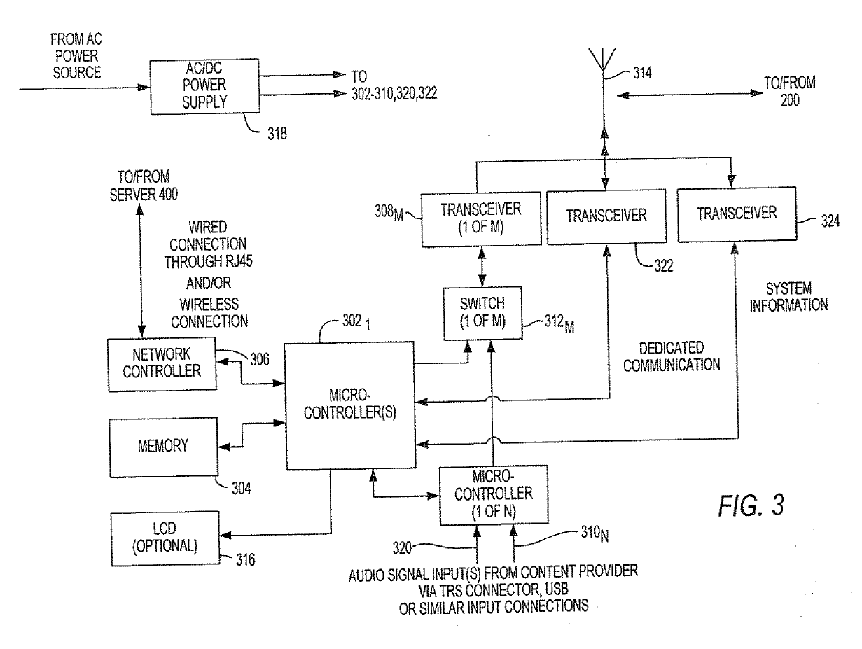

In one embodiment, the transceiver 208 has frequency hopping capabilities and is able to receive wireless audio streams from any one of the transceivers 308ₘ (FIG. 3) of the local base station 300 over a selected channel, as well as system messages, audio, and/or data from transceivers 322 and 324 (FIG. 3) of the base station 300. Additionally, the transceiver 208 sends system messages as well as periodic ping or heartbeat signals to the local base station 300 via the wireless antenna 214.

The receiving device 200 includes a plurality of input and output devices, such a user input buttons or switches 216 to control channel selection (e.g., cycle up/down), volume (up/down), an “Accept” or “Enter” button, among other device functions. An LCD or other display can be included with or communicably coupled to the audio receiving device 200 to provide text messages, and the like. At least one illumination device (e.g., LED) can be provided to indicate power from the battery 218, channel operation, and the like. At least one speaker 210 is provided to play back audio messages including secondary audio content 112 associated with the programming being viewed, command instructions, interactive games, among other audio content. An output jack 220 for coupling a separate stereo headset can be optionally provided.

The housing of the audio receiver 200 is preferably oval in shape to permit coverage over the ear of an end-user and has a flexible shell that enables the user to press on the shell at predetermined locations which serve as the buttons or switches to control the receiving device 200. The input switches 216 are preferably touch-sensitive and enable a user to cycle through the channels, and send basic command signals (e.g., Yes and No commands) to the base station 300 for interactive programming. A person of ordinary skill in the art will appreciate that the shape and configuration of the switches 216 of the receiver 200 are not considered as being limiting. In one embodiment, the outer surface of the audio receiver 200 is formed substantially planar or convex to readily permit advertising to be printed on or otherwise adhered to the outer surface of the receiver 200 for easy viewing.

The power source 218 is preferably a DC battery including, but not limited to, alkaline battery cells, solar power source, a pollutant/toxin-free chemical power source, among any other well-known DC batteries capable of providing the necessary power to the microcontroller 202, transceiver 208, and the other components of the mobile receiving device 200. In one embodiment, the power source 218 is an eco-friendly battery that is activated by applying an external pressure to the housing of the audio receiver 200 at a specific location to cause a brittle container (not shown) to crack open and allow an electrolytic liquid therein to interact with a carbon/magnesium powder mixture to form a battery. In one embodiment, the eco-friendly battery creates a power source that lasts for approximately 24 hours. The receiving device 200 is safely disposable after the battery power is exhausted. Advantages of the eco-friendly battery are long shelf life, since the powdered mixture is separated from the liquid electrolyte. Further, the battery is not toxic after disposal. A person of ordinary skill in the art will appreciate that other types of batteries can be used. Optionally, a DC-to-DC converter (not shown) can be provided, depending upon the operating voltage of the electronics housed within the mobile receiver 200 and the voltage output of the power source(s), to ensure that the components of the receiver 200 will operate properly.

Referring to FIG. 3, a schematic block diagram of a base station 300 suitable for transmitting the audio content in the system of FIG. 1 is shown. The base station 300 includes at least one first microcontroller 302, memory 304, a network controller 306, a plurality of transceivers 308₁ through 308ₘ (collectively transceivers 308), at least one wireless antenna 314, a plurality of secondary microcontrollers 310ₙ, a plurality of switches 312ₘ, one or more illuminable devices (e.g., LCDs) 316, a power supply 318, and transceivers 322 and 324.

The network controller 306 communicates with the first microcontroller 302 and is used to connect to the Internet 102 and stream audio from the remote servers 400. The first microcontroller 302 is used as a central processor for controlling various functions including, but not limited to managing activation states of the audio receiving devices 20, validating a retailer's credentials and accounts with the server 400, as well as maintain file systems to store/retrieve various audio snippets (e.g., advertisements, announcements, trivia games, among other voice messages). The microcontroller 302 also controls broadcasting of local system information to the audio receiving devices 200, such as language selection, menu systems, button configuration, and other control information. Additionally, the microcontroller 302 controls audio flow through each wireless channel. That is, the microcontroller 302 controls the audio flow as to whether the primary audio content 110 such as the streamed audio content from the service provider (e.g., TV programming) is transmitted and/or the secondary audio content 112 such as the audio snippets (e.g., advertisements, announcements, trivia games, among other voice messages) are transmitted to the receiving devices 200.

The memory 304 can be flash memory or expanded memory (e.g., disc drives) among other well-known memory devices. The memory 304 stores programs and data that are executed by the microcontrollers 302 and 310 as required. The memory 304 can store commercial audio files, such as advertisements that will be replayed by the receiving devices 200 multiple times during an event. In this manner, the use of the memory 304 at the base station 300 eliminates the need for the same file to be periodically streamed to the receiving devices 200 over the Internet 102 from the servers 400. Rather, the audio is transmitted directly from the memory 304 of the base station 300 to the receiving devices 200. The base station 300 downloads files from the server 400 only when such file is not previously stored in the memory 304. This can include new files as well as updated files that are downloaded to the memory 304 of the base station 300.

Each base station 300 is capable of providing a different audio stream over each of a plurality of channels. In one embodiment, each base station 300 has ten channels although the number of channels is not limited. Each channel has an associated secondary microcontroller 310ₘ, switch 312ₘ, transceiver 308ₘ, and audio signal input 320. The secondary microcontrollers 310ₘ provide direct broadcasting of the audio streams to the receiving devices 200. The microcontroller 310 can be a model no. ATXMega32A4 microcontroller manufactured by Atmel Corporation of San Jose, Calif. or any other well-known microcontroller. Each secondary microcontroller 310 encodes one or more of the audio signal inputs and communicates the encoded signal via a corresponding transceiver 308. The microcontroller 310 processes, digitizes and packetizes the analog audio input signals for wireless transmission, as well as communicates with the primary microcontroller 302 to exchange various data signal. The quantity of the secondary microcontrollers 310 corresponds with the quantity of physical analog audio sources 320 installed in the base station 300.

A transceiver 308 is dedicated for each broadcasting channel and encodes and transmits the outgoing audio signals via the antenna 314 over the wireless network 105. An audio signal input 320 can be a physical connector or jack (e.g., ¼ inch jack) for providing audio content to the base station 300. Each audio signal input 320 represents a separate and dedicated channel. A switch 312 is dedicated to each channel as well. Each switch 312 can be a digital switch that is controlled by the primary microcontroller 302 to allow selection of digitized audio source. The digital audio sources can be broadcasted audio content, such as audio content received from an external content provider such as a cable TV provider, or satellite TV provider, or a local content provider such as an IPOD™ or a jukebox of the retailer 122, or any other source of digital audio. Accordingly, each channel of the base station 300 can contemporaneously receive different audio input from different audio sources. For each channel, when the switch 312 is in a normal state, direct broadcast audio streams are sent by the corresponding secondary microcontroller 310 to the corresponding transceiver 308. When the switch 312 is in an alternate state, secondary audio content 112, such as messages, audio snippets, advertisements and the like are sent by the corresponding microcontroller 310 to the corresponding transceiver 308.

The transceiver 322 is provided for receiving ping/heartbeat messages from the receiving devices 200, as well as receiving and transmitting other messages between the base station 300 and receiving devices 200. The transceiver 322 can be a single transceiver that operates over a range of frequencies. Alternatively, a plurality of transceivers 322 can be implemented, where a single transceiver 322 is assigned to each channel. Each transceiver 322 can operate at a dedicated frequency or be changed dynamically in response to command signals sent by the microcontrollers 302 and 310.

The transceiver 324 is dedicated for downloading data, sending/receiving command signals, and receiving audio content from the server 400. Additionally, the transceiver 324 is dedicated to upload data to the receiving devices 200, such as new game/polling menus, different language audio read-back files, and the like. The transceiver 324 can be a single transceiver that operates over a range of frequencies. Alternatively, a plurality of transceivers 324 can be implemented, where a single transceiver 324 is assigned to each channel. Each transceiver 324 can operate at a dedicated frequency or be changed dynamically in response to command signals sent by the microcontrollers 302 and 310.

Accordingly, the transceivers 308, 322, 324 receive as input, digitized, packetized data and transmits this data wirelessly via the antenna 314 using such protocols as IEEE 802.11, IEEE 802.15.4, and the like with specifications such as ZigBee, BitCloud, Ipv6/6LowPAN, and the like. The transceivers 308, 322, 324 can be a 2.4 GHz transceiver such as a model no. AT86RF231 transceiver fabricated by Atmel Corporation or transceiver model no. TRC104 which is fabricated by RF Monolithic, Inc of Dallas Tex., among other well-known transceivers.

In addition to passing along audio content from the rear audio inputs of the base station 300, the retailer 122 has the ability to use a computer device 104 to remotely access a base station configuration control panel 126 by accessing the server 400 of the service provider 120 through the local network and/or internet 102. The control panel 126 allows the retailer or account holder to configure the operation of the base station 300 remotely from the computer device 104.

Specifically, the retailer 122 can view/modify the account information through the internet-based control panel display 126. The account information includes general accounting information such as names, addresses, as well as detailed information such designated audio files that the account holder may wish to download to the base station 300. For example, the retailer or account holder can view, i.e., from the display of the computer device 104, a list of unique audio programs that are available for streaming from the server 400 or other audio source available over the Internet, and assign a selected audio stream to any one of the channels of the base station 300. The control panel 126 also allows for remote setup and diagnostics of the base station 300, including various tasks such as mapping of sources to channels/inputs, advanced setup instructions, remote troubleshooting, among other managerial and configuration operations.

Once the retailer 122 selects and assigns an audio stream from the Internet 102 to a specific channel, the base station 300 automatically switches from the audio source being provided through the physical audio jack 320 associated with the selected channel, to the streaming audio from the internet 102 that is assigned to the selected channel. The ability to provide audio content from an alternative source such as streamed audio content from the internet 102 gives the retailer 122 additional flexibility to enter various markets where television sets and sports are not the focus, such as for example, the hospitality industry, including, hotels and resorts. Illustratively, hotel guests may forget to bring their high-cost electronic devices with them or be reluctant to carry them near recreational areas and pools for the risk of damaging them or theft. Conveniently, the hotel may provide the disposable mobile receivers 200 which are able to receive multiple channels of audio content the hotel has selected for its guests, and listen to the audio content while participating in their recreational activities.

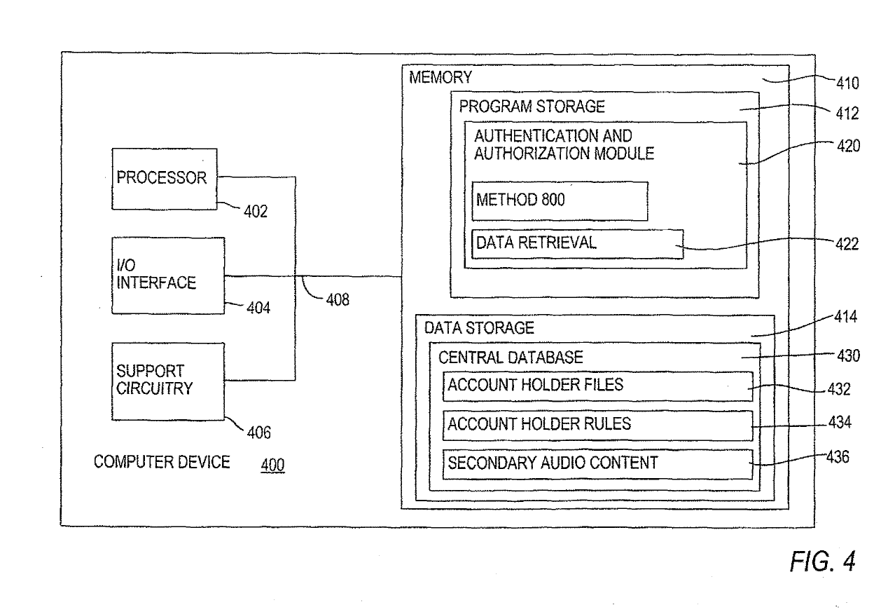

Referring now to FIG. 4, the server 400 of the service provider 120 can be one or more remote servers that centrally manage the account holder information and execute programs to provide account authentication, base station authentication, and audio content to the base stations associated with the authenticated account holders. The server 400 includes a multitasking, real-time software technology that can concurrently handle hundreds of thousands of queries and updates.

The server 400 can be any computer device such as a personal computer, minicomputer, workstation or mainframe, or a combination thereof. While the computer device 400 is shown for illustration purposes as a single computer unit, the system may comprise a group/farm of servers which can be scaled depending on the processing load and database size.

Specifically, the computer device 400 comprises at least one processor 402, as well as memory 410 for storing various control programs, such as authentication and authorization programs 420. The processor 402 may be any conventional processor, such as one or more INTEL® Processors. The memory 410 can comprise volatile memory (e.g., DRAM), non-volatile memory (e.g., disk drives) and/or a combination thereof. The processor 402 cooperates with support circuitry 406, such as power supplies, clock circuits, cache memory, among other conventional support circuitry, to assist in executing software routines (e.g., method 800) stored in the memory 410. The one or more processors 402, memory 410 and support circuitry 406 are all commonly connected to each other through one or more bus and/or communication mediums (e.g., cabling) 408.

The computer device 400 also comprises input/output (I/O) circuitry 404 that forms an interface between various functional elements communicating with the computer device 400. For example, the computer device 400 is connected to a communication link (e.g., Internet) through an I/O interface 404, which receives information from and sends information over the communication link to various base stations 300 and the remote computer devices 104 of the account holders.

The memory 410 includes program storage 412 and data storage 414. The program storage 412 stores the authentication and authorization module 420 of the present invention, an operating system (not shown), such as a WINDOWS® operating system, among other application programs and data retrieval modules 422. The data storage 414 can be an internal or separate storage device, such as one or more disk drive arrays that can be accessed via the I/O interface 404 to read/write data. The data storage 414 includes a central account database 430 which includes customer account files 432, as well as the corresponding account holder rules 434, both of which are generated by the customers during the enrollment process in accordance with the present invention, among other information. The data storage 414 can also store secondary audio content, such as advertisements, among other audio information for downloading to the base station 300. The central account database 430 can be provided internally (as shown in FIG. 4) or externally to the computer device 400. Any of the software program modules in the program storage 412 and data from the data storage 414 are transferred to specific memory locations (e.g., RAM) as needed for execution by the processor 402.

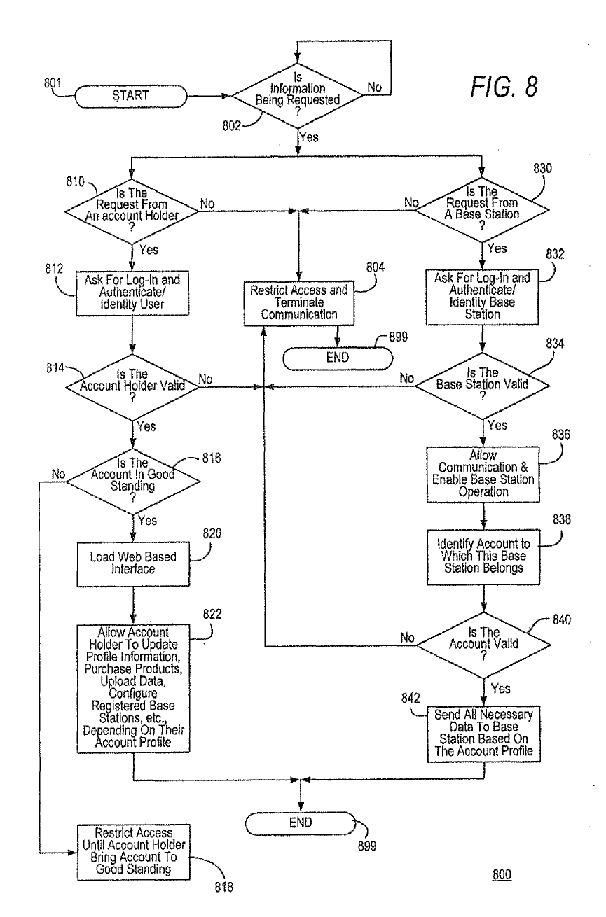

As such, it is contemplated that some of the process steps discussed herein as software processes may be implemented within hardware, for example, as circuitry that cooperates with the processor 402 to perform various steps, such as those set forth below with respect to method 800 of FIG. 8. It is noted that the operating system (not shown) and optionally various application programs (not shown) are stored in the memory 410 to run specific tasks and enable user interaction.

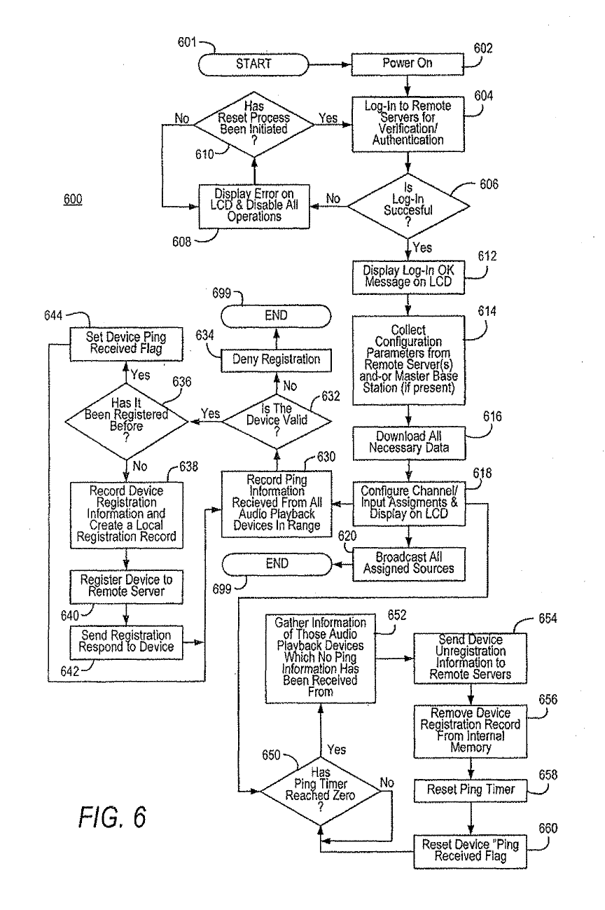

Referring to FIG. 6, a flow diagram of a method 600 for operating the base station of FIG. 5 illustrating self-configuration and monitoring activities of one or more mobile audio receiving devices of FIG. 2 is illustratively shown. Initially, the retailer or proprietor of an establishment offering the audio content services of the present invention must establish an account with the service provider 120. In one embodiment, the retailer 122 must provide profile information such as demographic information, such as types of services the establishment offers, location, customer traffic, among other marketing information. Once the retailer's account is established and is in good standing, the retailer 122 can offer the audio services to its customers.

The method 600 starts at step 601 and proceeds to step 602, where the base station 300 is powered on. At step 604, the base station undergoes a remote login process in which the base station “boots up”.

Authentication with the remote servers 400 occurs so that the remote server 400 will recognize the base station 300. In one embodiment, the MAC address of the base station is sent to the remote servers for identification. Once the base station 300 is identified (authenticated), it logs in at the remote server 400 of the service provider 120.

At step 606, once the base station logs in, at step 612 it provides indication of a successful login to the retailer, for example by illuminating a green colored LED or providing text message on a display panel of the base station 300. Alternatively, at step 608, if there is a log-in error, an error message is displayed on the base station 300 and its operation is disabled. At step 610, a reset process can be initiated a predetermined number of times to try to log in to the server 400. The reset process can be done either automatically by the software programming or manually by a user cycling power to the base station.

Once the base station 300 has logged in to the server 400, at step 614, configuration parameters from remote server 400 (and/or a master base station if more than one base station is being used by a retailer) are collected and stored in the memory 304 of the base station 300. The configuration parameters can include any data such as audio or programming data that needs to be stored in the base station 300 from the remote servers 400.

For example, if the base station 300 illustratively has ten input channels, when the base station 300 is turned on it checks with the account records stored at the server 400 to see what configuration is required, and how it should configure itself first. Illustratively, Channel 1 could be assigned a physical input or it could be assigned an internet stream. All that information would be received at that point. Alternatively, Channel 1 could be assigned as an internet stream, Channel 2 is assigned a physical input channel, Channel 3 is assigned another internet stream, and so forth.

At step 616, all necessary data is downloaded. Thus, if the base station 300 is configured differently than what the remote server 400 has stored in its memory 414 as the proper programming, the correct data is downloaded to the base station 300 in accordance to its configuration information. The data can include, for example, secondary audio content 112 such as audio bits (e.g., audio snippets) that it plays for the particular establishment. Such data is based on the profile information of the establishment, meaning if it's a stadium it's one kind of information, if it's a bar it's another.

Furthermore, the retailer 122, such as an owner of a sports bar could have multiple audio snippets downloaded into the memory 304 of the base station 300 for a desired length of time.

After the configuration parameters are collected from the server 400, at step 618, the base station 300 uses the configuration parameters to configure itself at that point based on the profile information. For example, there can be different account levels that they pay different monthly dues. One of them can be, for example, $49.99 for 4 channels enabled, another can be 10 channels enabled for $100, and so forth. Accordingly, some channels are assigned according to the configuration profile of the vender, while other channels might be enabled or disabled.

After the base station 300 is configured, an indicator, such as an LED or text will be displayed on the base station 300 to identify the active channels, e.g., physical input, an internet stream, and so forth.

At step 620, the base station 300 broadcasts the assigned sources over the channels to the mobile receiving stations 200. The assigned sources can be television programming, or other multimedia programming from a service provider 120. In particular, the broadcast audio that is coming from a source goes through base station 300 and is re-transmitted to the mobile receivers 200. The illustrative broadcast audio is the primary audio stream 110 illustratively shown in FIG. 1.

For example, if a user is at a sports bar with eight televisions broadcasting eight different football games on Sunday afternoon, anyone could watch and listen to any one of those games he wanted to, and without disturbing his neighbors. Each channel of the base station 300 broadcasts different primary content 110 at a different frequency and the user is able to tune to the assigned frequency associated with the game being watched on the corresponding television set by pressing the channel button on the receiver 200. Thus, at step 620, all active channels broadcast different primary audio content simultaneously, and the end-users can tune to, i.e., select, any of the channels being rebroadcast by the base station 300 using their mobile receiver 200.

While the base station 300 is broadcasting the audio content, e.g., television programming, the base station 300 also concurrently receives the heartbeat information from any mobile receiving devices 200 in its vicinity. The base station 300 includes a counter which monitors the mobile receivers 200 to keep track of them.

For example, heartbeat information from each mobile receiver 200 can be monitored as a person enters and leaves a location, for example, a museum having various exhibits in different sections or areas of the museum. Therefore, the heartbeat count can change during the course of broadcasting the primary audio content 110.

Referring again to FIG. 6, at step 630, the base station 300 records the ping or heartbeat information from all the mobile receivers 200 in range. At step 632 if a mobile receiver device 200 is not deemed valid, at step 634, registration is denied. For example, if a user is in a first bar with a base station 300 and then walks away to a location that is out of signal range of the base station of the first bar, the base station no longer in range needs to “check-out” the receiving device 200 in that retailer establishment. In this manner, if the user walks into a second bar or establishment with a different base station, that new base station must “check-in” and recognize the mobile receiver once the user comes into signal range. In this manner, registration is denied so that one mobile receiver is not registered at two or more different base stations at a particular time. Further, registration is denied in the event of a counterfeit receiver device 200 being used.

If at step 632 the receiving device 200 is valid, e.g., the same person walks back into that first establishment, at step 636, the base station 300 determines if the mobile receiver 200 was previously registered. If the mobile receiver 200 is registered, at step 644 a flag is set indicating such registration and the heartbeat/ping information is monitored again at step 630. Alternatively, if the receiving device 200 is not previously registered, the method 600 proceeds to step 638, where the registration information for the receiving device 200 is recorded by the base station 300. The base station 300 then sends this registration information to the server 400 at step 640. At step 642, the base station 300 receives an acknowledgement and the registration response message is sent to the receiving device 200, where at step 630, the heartbeat/ping information of the newly registered mobile receiver 200 is monitored.

In one embodiment, the servers 400 keep track of the number of mobile receivers 200 that are operational at a given time for a specific programming. This information can be useful for advertising purposes. That is, the server 400 can track a real time number of how many mobile receivers 200 are registered with a specific base station 300. In this manner, an advertiser can determine how many people are actually listening to a program and adjust its programming based on demographics, time and other profiling information.

At step 650, a counter in the base station 300 is set to a predetermined time and counts down until the timer is zero. At step 652, the base station identifies those mobile receivers that have not sent any ping information in the last counter cycle. At step 654, the base station sends the ID information of the mobile receivers 200 that are turned off and/or out of range to the servers 400. At step 656, the server 400 removes the registration information of the audio receivers 200 from its internal memory, thereby unregistering the mobile receivers 200 that did not send any ping information in the previous counter cycle. At step 658 the ping timer (counter) is reset and the method 600 continues until there are no longer any registered mobile receivers 200 sending ping messages back to the base station 300. At step 699, the method 600 ends.

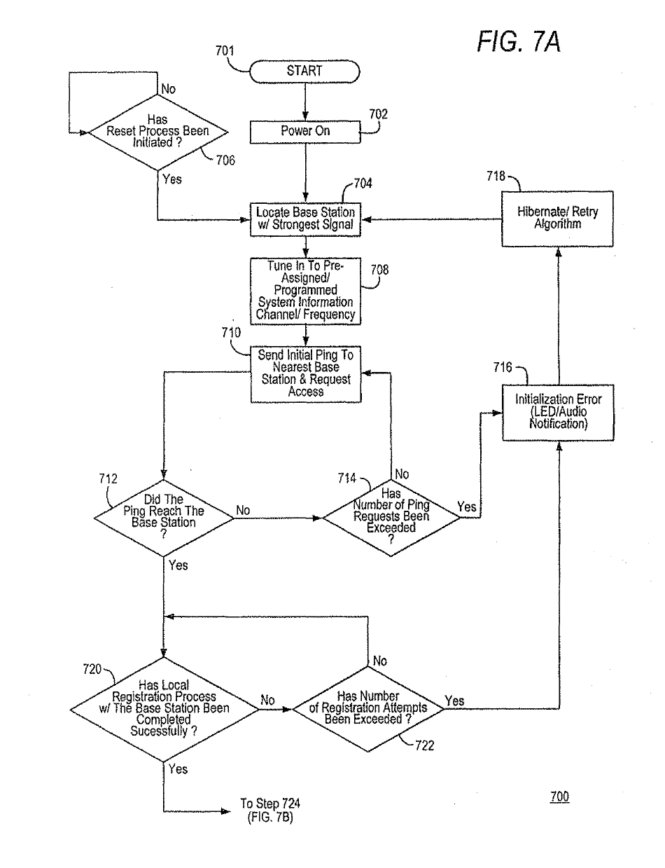

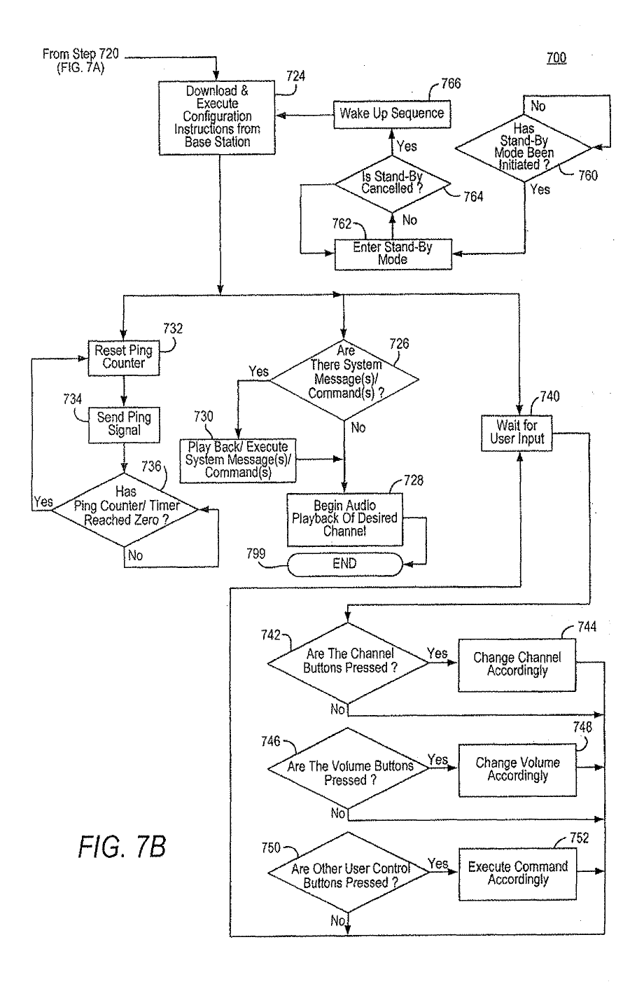

Referring to FIGS. 7A and 7B, a flow diagram illustrating a method of operation 700 of the mobile audio receiving device 200 of FIG. 5 illustrating self-initialization and configuration, and communications with the base station 300 is shown. The method 700 starts at 701 and proceeds to step 702, where the receiver device 200 is powered on. At step 704, the receiving device 200 locates a base station 300 having the strongest transmission signal. It is noted that a retail establishment 122 can have multiple base stations to provide additional channels and/or increase the range of access. For example, a smaller type establishment, such as a bar or restaurant may have a single base station, while a large sports bar, museum or stadium can have multiple base stations that are linked together from the perspective of the server. Alternatively, two adjacent establishments can each have a base station 300, and the receiver 200 will locate the base station with the strongest output signal, which is typically the one closest in range.

Alternatively at step 706, if a user with a mobile receiver 200 moves to a new location (another bar) and comes into range of another base station 300 the method 700 proceeds to step 704, where the mobile receiver locates the base station with the strongest signal.

At step 708, the receiver 200 tunes in to a pre-assigned system information channel. The channel and frequency information is preprogrammed in the microcontroller 216 of the receiver 200. This allows the receiver 200 to undergo the configuration and registration process discussed below in steps 710-722.

At step 710, an initial ping is sent by the newly activated receiver 200 to the local base station 300. If the initial ping is not acknowledged by the base station after a predetermined number of tries, an error message is provide on the device 200 at step 716.

If the ping message is received by the base station 300, at step 720 a determination is made whether the registration process with the base station is successful. The registration step includes configuration of channel assignments, i.e., frequencies of the channels, data that needs to be stored in the receiver 200, for example, audio snippets or programming data. If the registration process has not been successful after a predetermined number of times, an error message is provided on the mobile receiver and the receiver is disabled or placed in hibernation mode.

Additionally, the microcontrollers 202 or transceivers 208 can have numerous channel capabilities. During configuration, bandwidth constraints can be set to include spacing between frequencies to prevent cross talk. Further, the distribution of the channel frequencies and spacing can be changed dynamically based on increased or decrease channel usage.

Referring to FIG. 7B, if the registration with the base station 300 is successful, at step 724, the configuration instructions are downloaded to the receiver 200 from the base station 300. At step 726, any messages or instruction commands from the base station 300 are sent to the mobile receiver 200 for the end-user to listen to and follow accordingly. At step 730, the messages or commands are played over the speaker of the receiver 200 to the user. Such messages can include directions how to operate the device, select a particular channel and/or volume, and the like.

An audio message downloaded from the base station 300 will be played immediately upon powering on the unit 200. For example, a message can be provided to tell the end-user that the receiver is being configured and to stand by until completion. Languages instructions, such as for example, if you want to listen in French, press 1, for English press 2, for Spanish press 3, and then the receiver 200 waits for the input.

Further advertising messages for the establishment can be given, such as “Hello welcome to Joe's Tavern, Happy Hour is from 4:00 pm to 6:00 pm”. Accordingly, a prerecorded message from the base station 300 will initially play back before it starts to play back the primary audio 110 from the selected channel programming. This prerecorded message is a secondary audio message 112 with respect to the primary content 110 (e.g., television programming) being broadcasted from the content provider 130 via the base station 300.

In one embodiment, the primary content 110 can be interrupted at predetermined intervals, such as every fifteen minutes to permit the broadcasting, multicasting or pointcasting of the secondary content 112 to the mobile receivers 200. Alternatively, the retailer 122 can interrupt the primary audio content on-demand in order to stream the secondary audio source at any time, whether planned or unplanned. For example, a restaurant employee can use a microphone that is plugged into an input port of the base station 300 in order to inform all customers of a meal “special” that is currently being offered to the patrons. Specifically, the restaurant employee presses the “talk” button on the microphone commands the microcontroller of the base station to interrupt all primary content audio streams 100 and deliver the employee's verbal message(s) as secondary content 112 from the microphone to the mobile receivers 200.

At step 732 during normal mode of operation, the ping counter is reset to a predetermined time or value and counts down (e.g., 5 seconds, 30 seconds, among other predetermined times). At a predetermined time, a ping signal is sent to the base station for tracking purposes, as described above with respect to the method of FIG. 6. At step 736, the ping counter/timer is reset when it counts down to zero.

At step 728, the user tunes to the desired audio channel, such as a channel associated with a particular television program, and listens to the primary audio programming content 110. At step 740, the receiver 200 waits to receive a new user input. For example, if at step 742 a channel button is pressed, then at step 744 the channel is changed accordingly. If at step 746 the volume control is pressed, then the volume of the audio through the receiver speaker is increased or decreased accordingly. Alternatively, if other controls on the receiver 200 are pressed, then the microcontroller 202 of the receiver 200 will execute the commands to enable/disable such other control functions. Such other controls can include buttons for playing interactive games, ringing for service from the local establishment, among other control functions.

At step 760, if there has been no activity for a predetermined time, in one embodiment, the receiver 200 enters a stand-by mode, for example, to conserve battery life. Alternatively, the user can initiate a standby mode of operation to conserve battery life. At step 762, stand-by mode is entered. If at step 764 stand-by mode is canceled, then at step 766, a wake-up sequence is initiated and the method returns to step 724 to ensure that it is still registered. When the user is finished listening to the audio, at step 799, the process is terminated.

Referring now to FIG. 8, a flow diagram of a method of operation 800 of a remote server 400 of FIG. 5 illustrating authentication, authorization and access of retailer accounts to the system of FIG. 1 is illustratively shown. The method 800 starts at step 801 and proceeds to step 802 where the server 400 waits for a request for information. At step 810, if a request from an account holder (e.g., proprietor at a bar, restaurant, museum, sports stadium, and the like) is received over the Internet 102 to access the account, at step 812, the account holder must log in and authenticate himself over the website. If at step 814, the account holder authentication is not valid, then at step 804, access is terminated.

Otherwise, the method 800 proceeds to step 816 where a determination is made if the account holder is in good standing. If the determination is negative, access to the account holder is restricted until the account is in good standing (e.g., timely payment of service fees by the account holder and the like). If the account is in good standing, at step 820, the web site is loaded for interface by the account holder. At step 822, the account holder can update profile information, purchase products, upload data, configure registered base stations, and the like. The method 800 ends at step 899 when the account holder logs off the web site interface.

Alternatively, if at step 830, the request is from a base station 300, the method proceeds to step 832, where the base station 300 proceeds with a log-in and authentication process. If at step 834 the log-in process is not successful, then at step 804, access by the base station 300 is terminated. If at step 834 the log-in process is successful, then at step 836, the base station 300 communicates with the server 400 and at step 838, identifies the account of the account holder. If the account is not valid, access is denied. Otherwise, the server 400 sends the required data to the base station based on the account holder's profile. At step 899, the method 800 ends.

In one embodiment, primary audio broadcasts can be interrupted at predetermined times (e.g., every 15 minutes) to deliver a single 15-30 second advertisement (i.e., secondary content 112) to the end users. The minimized duration of the advertisements helps discourage users from taking off the receiver 200 during each advert. In determining the price for each broadcast advertisement, advertisers can have control over and real-time information as to where their advert has been delivered and how many receivers 200 have played them back to their users. Advertisers can be charged a formulated price based on number of impressions and the markets in which they are heard.

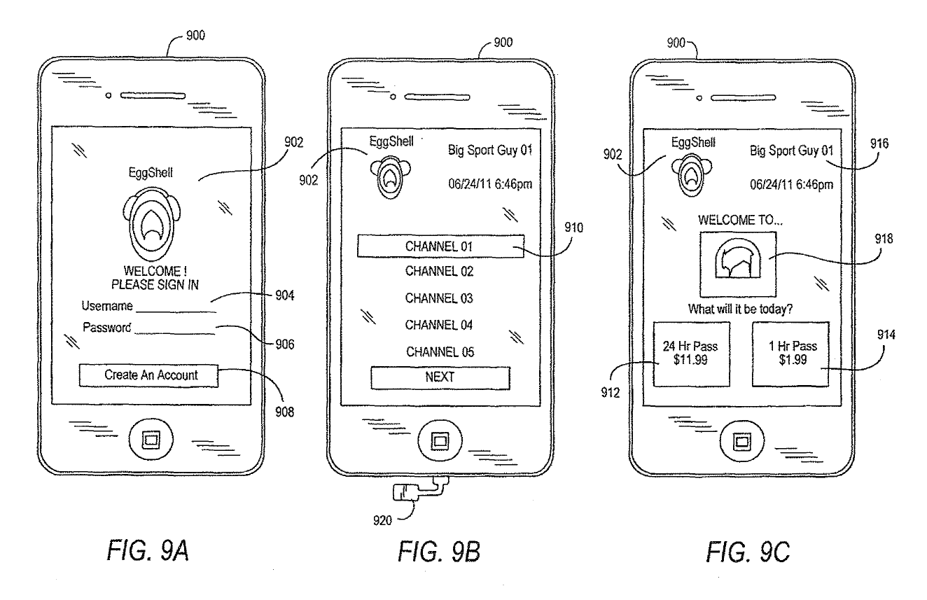

Referring to FIGS. 9A-9C, in yet another embodiment, the mobile receiver 200 is a cellular telephone i.e., a conventional “smart phone” 900 having internet access via Wi-Fi connectivity. The smart phone 900 can be any well-known cellular telephone having internet capabilities, such as a Blackberry™, an Android™ or an iPhone™ cellular telephone and the like.

The cell phone 900 includes an application (“App”) program 902 which is downloadable from the service provider 120 or the manufacturer of the cell phone 900. The application program 902 enables the end-user to access the internet 102 via the retailer's wireless LAN 103 and receive the primary audio content 110 and the secondary audio content 112 in a similar manner as described above with respect to the mobile receivers 200.

In particular, instead of using a completely separate wireless signal to receive the audio content from the base station 300, the audio content is transmitted using a conventional Wi-H signal hosted by the retail establishment's local area network (LAN) 103. In this embodiment, the base station 300 is also configured to access and communicate over the LAN 103 of the retailer 122. The base station 300 broadcasts (or multicast or unicast) the audio content 110, 112 using the same Wi-Fi infrastructure that is being used to provide the retailer's customers with their connectivity to the internet 102.

In one embodiment, the end-user downloads the App program 902 from the service provider 120 and installs it on the cellular phone 900. Once the application program 902 is launched, the application program finds the local Wi-Fi signal from the LAN 103 of the retailer 122 and either automatically enables the settings of the cell phone 900 to permit access to the LAN 103 or allows the end-user to enter a password if access is encrypted. In this latter case, the password is provided to the end-users by the retailer. The end-user control functions for changing channels, changing the volume, etc. are performed by the end-user through the App program 902 which is stored on the cell phone 900.

Referring to FIG. 9A, the downloaded application program 902 initially requests the end-user to create a new account with the service provider 120 by providing profile information including a user name 904, a password 906, contact information and billing information (e.g., credit card information). Once this profile information is entered, the user presses the “create new account” button 908 to submit the information and create the end-user's account with the service provider 120.

Thereafter, the end-user can login to the account by entering just the username 904 and password 906 at any time when visiting a retailer's establishment 122. Referring to FIG. 9B, the cell phone 900 connects to the LAN 103 of the retailer 122 and displays a list of channels 910 that the end-user can select. The retailer 122 can physically provide a list of available channels corresponding to the content that the retailer is offering to the end-users. For example, if the retailer 122 is a spots bar with multiple televisions each of which is tuned to a different broadcast channel, then the retailer can assign and display a distinct receiver audio channel for each television channel being broadcasted at the bar. Once the end-user selects a particular channel, the application program 902 generates a graphical user interface (GUI) that displays the end-user's username 916, an optional name/logo 918 of the retailer 122, and one or more options for paying for the audio content to be transmitted to the cell phone 900. As illustratively shown in FIG. 9C, the application program 902 displays an option for a one-time use fee 912 or a monthly fee 914, although such payment options are not considered as being limiting.

A person of ordinary skill in the art will appreciate that other end-user controls, such as volume and channel selection are performed by the end-user interaction with the cell phone 900 in a conventional manner to send the desired control signals to the base station 300 via the wireless LAN 103. For example, the volume controls can be the physical volume control buttons on the cell phone 900 or a GUI can be provided by the App program 902 to generate volume control buttons that the user interacts with on the display screen of the cell phone 900. In a similar manner, the heartbeat/ping messages and other control messages as describe above with the mobile receiver 200 are automatically communicated between the base station 300 and the cell phone 900 over the wireless LAN 103. The base station 300 sends the heartbeat/ping messages to the servers 400 at the service provider 120 as described above.

In an alternative embodiment, the delivery of the content to the end-user is provided by using a separate and unique wireless channel in a similar manner as describe above with respect to the mobile receiver 200, but still use the cell phone 900 with a customized application program 902 for control functionality. In this embodiment, the end-user can plug in a dongle 920 or other electronic device with an antenna into a jack (e.g., USB jack) available on the cellular phone 900. The dongle 920 includes an antenna for receiving and transmitting communication signals over a non-Wi-Fi wireless network channel 105, such as a 2.4 GHz channel. In this embodiment, the dongle 920 is used to receive 2.4 GHz wireless signals over the network 105, since conventional cell phones 900 are normally limited to communication over conventional Wi-Fi and Bluetooth networks, such as WLAN 103. In this embodiment, the application program 902 installed on the cell phone 900 serves as a control unit to provide end-user controls, receive primary audio and video content 110 from the content provider 130, as well as secondary audio and video content from the retailer 122 to the end-user. For example, the cell phone 900 is capable of receiving the primary audio and video from a broadcasted baseball game, as well as the secondary streams of content 112 including snippets and/or video images (e.g., menus, happy hour specials, games, and the like) from the retailer 122.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A method for providing primary audio content and secondary audio content over a local wireless network at a public or private forum to at least one mobile audio receiving device, the method comprising the steps of:
receiving the primary audio content from one or more content providers over a corresponding one or more communications paths;
transmitting selected primary audio content from one of the communications paths continuously over the local wireless network to the at least one mobile audio receiving device;
terminating transmission of the selected primary audio content to the at least one mobile audio receiving device at predetermined time intervals or on-demand;
transmitting the secondary audio content over the local wireless network to the at least one mobile audio receiving device while the selected primary audio content transmission is terminated, the secondary audio content being transmitted for a second predetermined time interval or on-demand; and
transmitting the selected primary audio content from the corresponding communications path continuously over the local wireless network to the at least one mobile audio receiving device after the secondary audio content being transmitted for a second predetermined time interval or on-demand has terminated.

2. The method of claim 1, further comprising the step of tracking activation of the at least one mobile audio receiving device while receiving the selected primary audio content over the local wireless network.

3. The method of claim 2, wherein the step of tracking comprises:
receiving periodic heartbeat or ping messages from the at least one mobile audio receiving device over the local wireless network; and
transmitting the received periodic heartbeat or ping messages to a remote server of a service provider that monitors status of the at least one audio receiving device.

4. The method of claim 3 further comprising deactivating the at least one audio receiving device in response to an absence of receiving the periodic heartbeat or ping messages for a predetermined time.

5. The method of claim 1, further comprising storing, at a remote server, profile information associated with the public or private forum.

6. The method of claim 1, further comprising transmitting the secondary audio content to the at least one mobile audio receiving device based on profile information of the public or private forum and/or one or more end-users.

7. The method of claim 1, further comprising configuring, over the local network and/or the Internet, channel selection for providing the selected primary audio content and the secondary audio content to the at least one mobile audio receiving device.

8. The method of claim 1, wherein the step of transmitting the selected primary audio content and the secondary audio content over a local wireless network comprises transmitting the selected primary audio content and the secondary audio content over a local non Wi-Fi wireless network.

9. The method of claim 1, wherein the step of transmitting the selected primary audio content and the secondary audio content over a local wireless network comprises transmitting the selected primary audio content and the secondary audio content over a local Wi-Fi network.

10. The method of claim 9, wherein the at least one mobile audio receiving device has Internet access over the local Wi-Fi network, the method further comprising providing a specialized application program to the at least one mobile audio receiving device, the specialized application program including at least one user interface for controlling channel selection for receiving the selected primary and secondary content over the local Wi-Fi network.

11. A system for providing primary audio content and secondary audio content over a local wireless network at a public or private forum to at least one mobile audio receiving device, the system comprising:
at least one mobile audio receiving device configured to receive selected primary audio content and the secondary audio content over the local wireless network;
a base station having a plurality of communication paths, and memory for storing profile information of the public or private forum, and at least one switch for selecting the primary audio content from one or more content providers, the base station further including at least one processor coupled to the memory and a base station configuration program stored in the memory and executable by the at least one processor, the base station configuration program operable to:
receive the primary audio content from the one or more content providers over a corresponding one or more communication paths of the plurality of communication paths;
transmit the selected primary audio content received from a corresponding communications path continuously over the local wireless network to the at least one mobile audio receiving device;
terminate transmission of the selected primary audio content to the at least one mobile audio receiving device at predetermined time intervals or on-demand;
transmit the secondary audio content over the local wireless network to the at least one mobile audio receiving device while the selected primary audio content transmission over the local wireless network is terminated, the secondary audio content being transmitted for a second predetermined time interval or on-demand; and
transmit the primary audio content continuously over the local wireless network to the at least one mobile audio receiving device after the secondary audio content being transmitted for a second predetermined time interval or on-demand has terminated.

12. The system of claim 11, wherein the local wireless network is a Wi-Fi network.

13. The system of claim 11, wherein the local wireless network is a non-Wi-Fi wireless network operating at a predetermined frequency.

14. The system of claim 11, wherein the base station includes a transceiver dedicated to each of the plurality of communication paths.

15. The system of claim 11, further comprising:
a remote server communicably coupled to the base station via the internet, the remote server including a second memory for storing the profile information of the public or private forum and a set of predetermined rules for determining assignment of the primary and secondary audio content to each of the plurality of communication paths; at least one second processor coupled to the second memory; and an authorization program and a base station management program stored in the second memory and executable by the at least one second processor, the remote server authorization program operable to:
activate operational capabilities of the base station over the internet;
send, over the Internet, configuration parameters for determining assignment of the primary and secondary audio content to each of the plurality of communication paths of the base station; and
send, over the Internet, a command signal to the base station to activate the at least one mobile audio receiving device over the local wireless network.

16. The system of claim 15, wherein the remote server is further operable to monitor activation of each of the at least one mobile audio receiving devices.

17. The system of claim 11, wherein the primary audio content received at the base station from the primary content provider includes at least one of broadcasted television programming, real-time audio content from a live performance, and digitized audio content stored on a memory device.

18. The system of claim 11, wherein the secondary audio content comprises at least one of advertisements, command instructions to operate the mobile audio receiving device, and command instructions for interacting with the primary audio content.

19. The system of claim 11, wherein the at least one mobile audio receiving device is activated only at the public or private forum.

20. The system of claim 11, wherein the at least one mobile audio receiving device comprises:
a microcontroller operable to execute input commands from the end-user to select one of the plurality of communication paths of the base station;
at least one transceiver operable to receive the selected primary audio content and the secondary audio content over the local wireless network; and
a speaker for outputting sounds associated with the selected primary audio content and the secondary audio content to the end-user.
